(19) United States
(12) Patent Application Publication
(10) Pub. No.: US 2024/0242237 A1
(43) Pub. Date: Jul. 18, 2024

(54) CUSTOMER CLASSIFICATION DEVICE, CUSTOMER CLASSIFICATION SYSTEM, CUSTOMER CLASSIFICATION METHOD, AND RECORDING MEDIUM STORING CUSTOMER CLASSIFICATION PROGRAM

(71) Applicant: NEC Corporation, Minato-ku, Tokyo (JP)

(72) Inventor: Shohei MARUYAMA, Tokyo (JP)

(73) Assignee: NEC Corporation, Minato-ku, Tokyo (JP)

(21) Appl. No.: 18/558,441

(22) PCT Filed: May 13, 2021
(86) PCT No.: PCT/JP2021/018195

§ 371 Date: Nov. 1, 2023

(51) Int. Cl. G06Q 30/0204

(52) U.S. Cl. CPC G06Q 30/0205

(57) ABSTRACT

This customer classification device 30 is provided with: an acquisition unit 31 which acquires customer attribute information 301 relating to customers, product attribute information 302 relating to products, and purchase history information representing the purchase history of the products by the customers; an estimation unit 32 which estimates purchasing factors 320 of said products by said customers on the basis of the customer attribute information 301, the product attribute information 302 and the purchase history information 303; a classification unit 33 which classifies the customers into groups 330 on the basis of the purchasing factors 320; and an output unit 34 which outputs the classification results of the customers. In this way, the purchasing factors can be identified even for products whose characteristics cannot be fully understood, so it is possible to contribute to sales or development of products fitting customers.

### TECHNICAL FIELD

The present invention relates to a customer classification device, a customer classification system, a customer classification method, and a recording medium storing a customer classification program.

### BACKGROUND ART

When companies and the like conduct marketing, customers are classified (also referred to as segmentation or clustering) in order to sell and develop products according to customers. Then, for example, after classifying customers into groups, factor analysis is performed for each group to identify a purchasing factor, and a technology for supporting such analysis work is expected.

As a technique related to such a technique, PTL 1 discloses a marketing device that associates sales information included in point of sale (POS) data with personal information about a customer, and classifies the customer into the group for each lifestyle of the customer by non-hierarchical clustering and hierarchical clustering. Furthermore, PTL 1 discloses that customers are segmented (classified) using domain knowledge of a product, and a purchasing factor is identified for each segment (group).

PTL 2 discloses a customer analysis system that quantitatively evaluates a customer's purchase preference type and assists in designing a purchase preference type having a high degree of coincidence with an actual product purchase history.

### CITATION LIST

### Patent Literature

PTL 1: JP 6181360 B1
PTL 2: JP 2016-136410 A

### SUMMARY OF INVENTION

### Technical Problem

In the techniques disclosed in PTLs 1 and 2, it is not possible to segment customers when a characteristic (attribute) of a product cannot be grasped (there is no domain knowledge of the product), and it is also difficult to identify a purchasing factor when customers cannot be segmented.

A main object of the present invention is to be able to classify customers and identify a purchasing factor even for a product whose characteristics cannot be sufficiently grasped.

### Solution to Problem

A customer classification device according to an aspect of the present invention includes an acquisition means configured to acquire customer attribute information about a customer, product attribute information about a product, and purchase history information indicating a purchase history of the product by the customer, an estimation means configured to estimate a purchasing factor of the product by the customer based on the customer attribute information, the product attribute information, and the purchase history information, a classification means configured to classify the customer into a group based on the purchasing factor, and an output means configured to output a result of classifying the customer.

In another viewpoint of achieving the above object, in a customer classification method according to an aspect of the present invention executed by an information processing device, the method includes acquiring customer attribute information about a customer, product attribute information about a product, and purchase history information indicating a purchase history of the product by the customer, estimating a purchasing factor of the product by the customer based on the customer attribute information, the product attribute information, and the purchase history information, classifying the customer into a group based on the purchasing factor, and outputting a result of classifying the customer.

From a further viewpoint of achieving the above object, a customer classification program according to an aspect of the present invention causes a computer to execute an acquisition process of acquiring customer attribute information about a customer, product attribute information about a product, and purchase history information indicating a purchase history of the product by the customer, an estimation process of estimating a purchasing factor of the product by the customer based on the customer attribute information, the product attribute information, and the purchase history information, a classification process of classifying the customer into a group based on the purchasing factor, and an outputting process of outputting a result of classifying the customer.

Further, the present invention can also be achieved by a non-volatile computer-readable recording medium in which the customer classification program (computer program) is stored.

### Advantageous Effects of Invention

According to the present invention, it is possible to identify a purchasing factor even for a product whose characteristics have not been sufficiently grasped, so that it is possible to contribute to sales and development of a product that matches customers.

### BRIEF DESCRIPTION OF DRAWINGS

FIG. 1 is a block diagram illustrating a configuration of a customer classification device 10 according to the first example embodiment of the present invention.

FIG. 2 is a flowchart illustrating an operation in which the customer classification device 10 according to the first example embodiment of the present invention generates an estimation model 150 (performs machine training).

FIG. 3 is a diagram illustrating an aspect in which the customer classification device 10 according to the first example embodiment of the present invention displays a result of classifying the customers on a display screen 200 of a management terminal device 20.

FIG. 4 is a diagram illustrating an aspect in which the customer classification device 10 according to the first example embodiment of the present invention displays details of attributes of individual customers on the display screen 200 of the management terminal device 20.

FIG. 5 is a flowchart illustrating an operation in which the customer classification device 10 according to the first example embodiment of the present invention classifies customers into groups.

FIG. 6 is a block diagram illustrating a configuration of a customer classification system 10A according to a modification of the first example embodiment of the present invention.

FIG. 7 is a block diagram illustrating a configuration of a customer classification device 30 according to the second example embodiment of the present invention.

FIG. 8 is a block diagram illustrating a configuration of an information processing device 900 capable of achieving the customer classification device according to each example embodiment of the present invention.

### EXAMPLE EMBODIMENT

Hereinafter, example embodiments of the present invention will be described in detail with reference to the drawings.

### First Example Embodiment

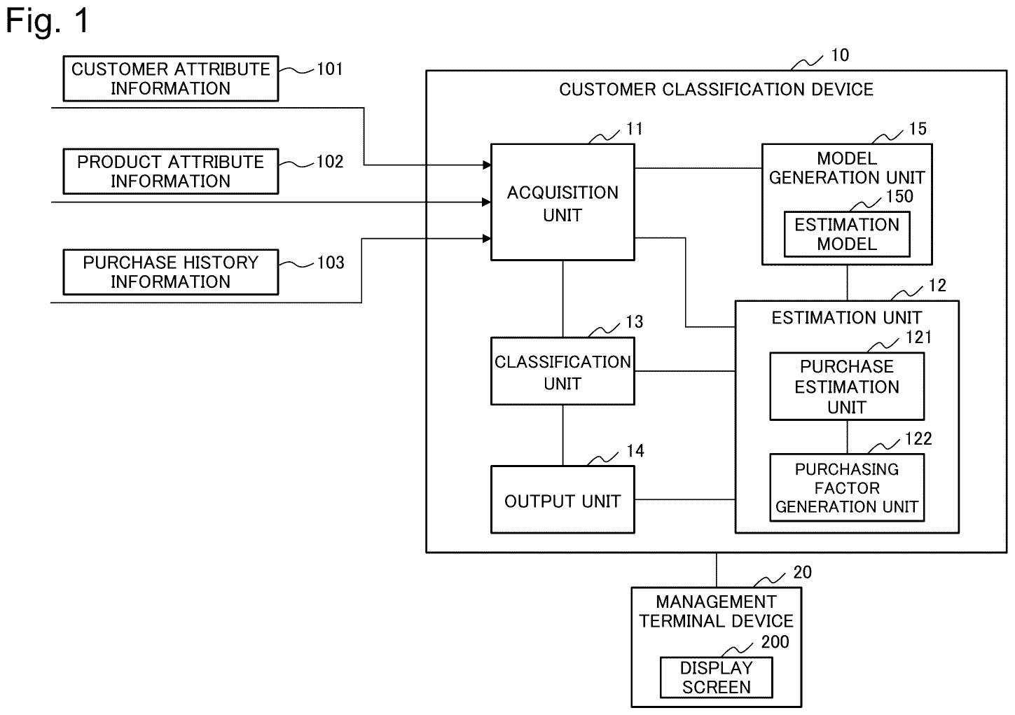

FIG. 1 is a block diagram illustrating a configuration of a customer classification device 10 according to a first example embodiment of the present invention. The customer classification device 10 according to the present example embodiment is a device that estimates a purchasing factor according to which a customer has purchased a product, and classifies customers into groups based on the purchasing factor.

A management terminal device 20 is communicably connected to the customer classification device 10. The management terminal device 20 is an example of the display device. The management terminal device 20 is, for example, a personal computer or another information processing device used when a user using the customer classification device 10 inputs information to the customer classification device 10 or confirms information output from the customer classification device 10. The management terminal device 20 includes a display screen 200 that displays the result of classifying the customers and the like output from the customer classification device 10.

The customer classification device 10 includes an acquisition unit 11, an estimation unit 12, a classification unit 13, an output unit 14, and a model generation unit 15. The acquisition unit 11, the estimation unit 12, the classification unit 13, the output unit 14, and the model generation unit 15 are examples of an acquisition means, an estimation means, a classification means, an output means, and a model generation means, respectively.

The estimation unit 12 includes a purchase estimation unit 121 and a purchasing factor generation unit 122. The purchase estimation unit 121 and the purchasing factor generation unit 122 are an example of a purchase estimation means and a purchasing factor generation means, respectively.

Next, an operation in which the customer classification device 10 according to the present example embodiment generates or updates, by machine training, an estimation model 150 illustrated in FIG. 1 used when estimating whether a customer with a certain attribute purchases a product with a certain attribute will be described. Next, an operation in which the customer classification device 10 classifies customers into groups using the generated or updated estimation model 150 will be described.

### <Operation of Generating (Updating) Estimation Model 150>

First, an operation in which the customer classification device 10 according to the present example embodiment generates or updates, by machine training, the estimation model 150 for estimating whether a customer with a certain attribute purchases a product with a certain attribute will be described.

The acquisition unit 11 acquires, for example, customer attribute information 101, product attribute information 102, and purchase history information 103 registered in an external computer device, database, or the like (not illustrated) as input information for training used to generate or update the estimation model 150.

The customer attribute information 101 is information indicating an attribute related to a customer as a training target registered in the database or the like. The customer may be, for example, an individual (consumer) or an organization (association) such as a company.

The customer attribute information 101 includes, for example, at least one of an age, a gender, an occupation, an income, a nationality, a family structure, a place of residence, a body shape, a hobby, a taste, an action history, a job category, and a position regarding the customer of the individual. The occupation includes, for example, white color or blue color. The family structure indicates, for example, the presence or absence of a housemate (whether the resident lives alone), whether the resident is a married person, the presence or absence of a child, and the like. The body shape indicates, for example, whether the customer is fat or thin.

The customer attribute information 101 includes, for example, at least one of a type of an organization, the number of years since establishment, an industry type, a place of a head office and a place of a business, revenue, capital, the number of employees, an activity history, and a form of business regarding a customer of the organization. The type of the organization includes, for example, a private company, a government office, and a local government. The industry type includes, for example, a manufacturing industry or a non-manufacturing industry. The number of employees includes, for example, the age structure of the employees. The form of business includes, for example, whether a business target is a business operator such as a company or a consumer.

The items included in the customer attribute information 101 are not limited to the above items.

The product attribute information 102 is information indicating an attribute related to a product as a training target registered in the database or the like. The product attribute information 102 includes, for example, at least one of a product name, a product identifier, a type, a quantity, a price, performance, reliability, quality, appearance, a manufacturer, a seller, a raw material, and a release date regarding the product. The items included in the product attribute information 102 are not limited thereto.

The purchase history information 103 is information indicating a history when a customer indicated by the customer attribute information 101 has purchased a product indicated by the product attribute information 102. For example, the purchase history information 103 includes information indicating whether the customer has purchased the product.

The model generation unit 15 generates or updates the estimation model 150 by performing training based on the customer attribute information 101 related to the customer as a training target, the product attribute information 102 related to the product as a training target, and the purchase history information 103 of the product by the customer. The model generation unit 15 uses the purchase history information 103 as a label in training, and determines an explanatory variable used when estimating whether the customer having the attribute indicated by the customer attribute information 101 purchases the product having the attribute indicated by the product attribute information 102.

For example, it is assumed that the customer attribute information 101 indicates that a certain customer is developing a new business, and the product attribute information 102 indicates that a certain product has a function as artificial intelligence (AI) capable of predicting a market trend for. It is assumed that the purchase history information 103 indicates that the customer has purchased the product. In this case, the model generation unit 15 determines, as an explanatory variable, that the customer is developing a new business and the product is AI capable of predicting the market trend.

Based on customer attribute information 101, product attribute information 102, and purchase history information 103, the model generation unit 15 generates or updates the estimation model 150 by generating or updating a criterion (rule) represented by the explanatory variable. For example, the model generation unit 15 updates the estimation model 150 in such a way that the larger the number of cases in which a customer who is developing a new business purchases AI capable of predicting a market trend, the greater the contribution degree of the explanatory variable in estimation of whether the customer purchases the product.

Alternatively, for example, it is assumed that the customer attribute information 101 indicates that a certain customer emphasizes at least one of reliability and performance of an information processing device, and the product attribute information 102 indicates that at least one of reliability and performance of a certain information processing device is high. Then, the purchase history information 103 indicates that the customer has purchased the information processing device. In this case, the model generation unit 15 determines that the customer emphasizes at least one of reliability and performance of the information processing device, and that at least one of reliability and performance of the information processing device is high as the explanatory variable.

The model generation unit 15 updates the estimation model 150 in such a way that the larger the number of cases where a customer who emphasizes at least one of reliability and performance of an information processing device purchases an information processing device at least one of reliability and performance of which is high, the greater the contribution of the explanatory variable in estimation of whether the customer purchases the product.

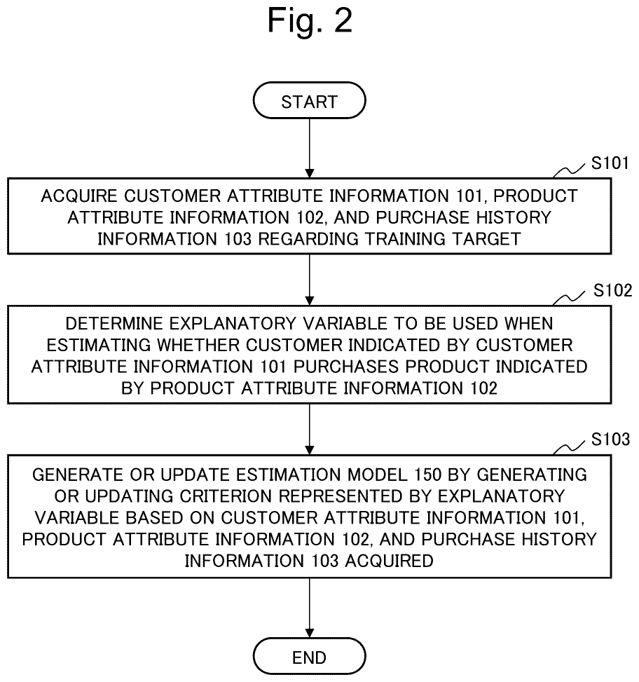

Next, an operation (processing) in which the customer classification device 10 according to the present example embodiment generates (machine trains) the estimation model 150 will be described in detail with reference to a flowchart of FIG. 2.

The acquisition unit 11 acquires the customer attribute information 101, the product attribute information 102, and the purchase history information 103 regarding the training target (step S101). The model generation unit 15 determines an explanatory variable used when estimating whether the customer indicated by the customer attribute information 101 purchases the product indicated by the product attribute information 102 (step S102).

Based on the customer attribute information 101, the product attribute information 102, and the purchase history information 103 acquired, the model generation unit 15 generates or updates the estimation model 150 by generating or updating the criterion represented by the explanatory variable (step S103), and the entire processing ends.

<Operation of Classifying Customers into Groups>

Next, an operation in which the customer classification device 10 according to the present example embodiment classifies customers into groups using the estimation model 150 generated or updated as described above will be described.

The acquisition unit 11 acquires the customer attribute information 101 about the customer and the product attribute information 102 about the product, which are used to estimate whether the customer to be estimated purchases the product to be estimated. Note that the customer and the product to be estimated may overlap with the customer and the product as training targets described above.

The purchase estimation unit 121 in the estimation unit 12 estimates whether the customer to be estimated purchases the product to be estimated based on the customer attribute information 101 and the product attribute information 102 acquired by the acquisition unit 11, and the estimation model 150.

The purchasing factor generation unit 122 in the estimation unit 12 generates the reason for estimating the reason for estimation by the purchase estimation unit 121 as a purchasing factor. The purchasing factor generation unit 122 is only required to generate the purchasing factor by using, for example, an attention mechanism of deep learning which is an existing technology. That is, the estimation model 150 is a model using an attention mechanism.

The classification unit 13 classifies customers into groups based on the purchasing factor generated by the purchasing factor generation unit 122.

The output unit 14 outputs a result of classifying customers into groups by the classification unit 13 to the management terminal device 20. The management terminal device 20 displays the result of classifying the customers, input from the output unit 14 on the display screen 200. When the customer classification device 10 includes a display screen, the output unit 14 may display the classification result on the display screen of the customer classification device 10.

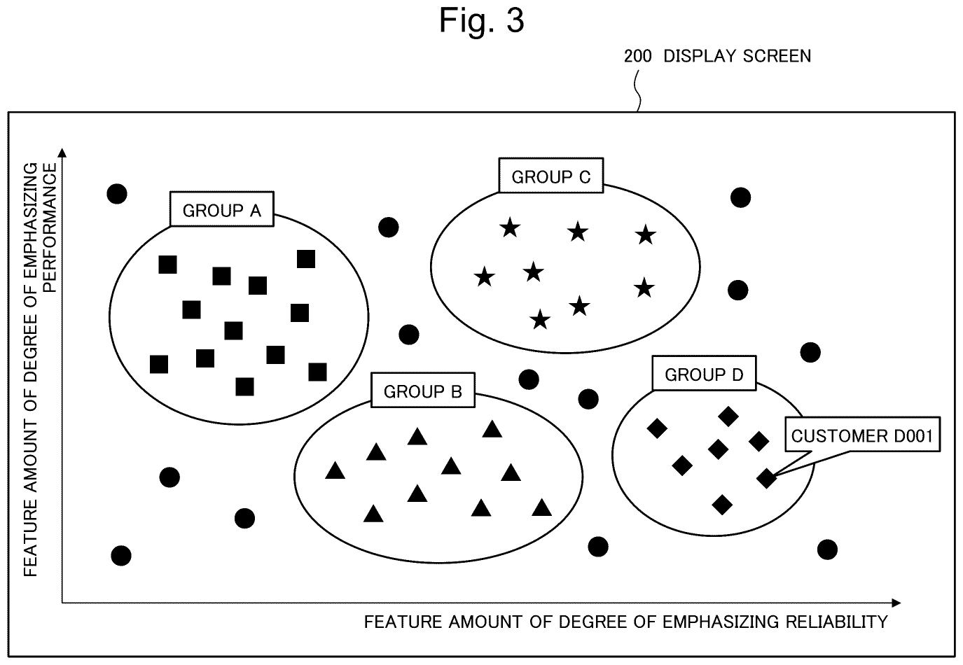

FIG. 3 is a diagram illustrating an aspect in which the customer classification device 10 according to the present example embodiment displays the result of classifying the customers on the display screen 200 of the management terminal device 20.

In the example illustrated in FIG. 3, the classification unit 13 classifies the customers with respect to two indices as a feature amount of a degree of emphasizing reliability and a feature amount of a degree of emphasizing performance, for example, with respect to the information processing device to be purchased, represented by the customer attribute information 101. Note that the index for classification is not limited to the above as long as it is a value or a feature amount indicating the customer attribute information 101 or a value or a feature amount indicating the product attribute information 102. The number of the indexes for classification is not limited to two.

The output unit 14 outputs a graph (scatter diagram and distribution diagram) representing a result of classifying the customers by the classification unit 13. In the diagram exemplified in FIG. 3, symbols of a quadrangle, a triangle, a star, a rhombus, and a circle represent individual customers.

In the example illustrated in FIG. 3, the classification unit 13 classifies customers into four groups A to D. Then, the output unit 14 outputs a graph displaying the customers in different aspects for the respective groups, one of which each customer belongs to. That is, in the graph, the output unit 14 displays the customer belonging to the group A with a square symbol, displays the customer belonging to the group B with a triangular symbol, displays the customer belonging to the group C with a star symbol, and displays the customer belonging to the group D with a diamond symbol. The output unit 14 also displays a customer not belonging to any group with a circular symbol. The output unit 14 may display the customers in different aspects for the respective groups, one of which each customer belongs to, in the graph.

The output unit 14 may also output a graph including a figure enclosing customers belonging to the same group. In the example illustrated in FIG. 3, the output unit 14 represents curves representing the individual regions of the groups A to D in the graph.

Next, in the example illustrated in FIG. 3, an operation of the customer classification device 10 that generates a purchasing factor when a customer purchases a product and classifies the customer into a group based on the generated purchasing factor will be described in detail.

The feature amount of the degree of emphasizing reliability and the feature amount of the degree of emphasizing performance described above can be obtained from information indicating a customer attribute that can be acquired from a result of a questionnaire survey of customers conducted, for example, at an event site such as an exhibition or on the Internet. In this case, the degree of emphasizing reliability and the degree of emphasizing performance may be, for example, values of degree self-evaluated by the customer using numerical values in the questionnaire survey.

Alternatively, the degree of emphasizing reliability and the degree of emphasizing performance may be values scored using predetermined calculation criteria from, for example, the industry type or company size of the customer. For example, a customer who is a financial institution such as a bank or a transportation facility such as a railroad company generally tends to place the most importance on reliability when introducing an information processing device that controls a social infrastructure, so that the degree of emphasizing reliability represented by the customer attribute information 101 regarding these customers tends to be a high value. For example, a customer who is a university, a research institute, or the like generally tends to place the most importance on performance in introducing an information processing device that performs scientific and technical operations, so that the degree of emphasizing performance represented by the customer attribute information 101 regarding these customers tends to be a high value. Since the budget for introducing the information processing device increases as the company scale increases, the degree of emphasizing both reliability and performance tends to increase. Therefore, the degree of emphasizing reliability and performance represented by the customer attribute information 101 tends to be a higher value as the customer is larger in scale. The degree of emphasizing reliability and the degree of emphasizing performance can be scored using a predetermined calculation criterion based on the above-described tendency.

The group A illustrated in FIG. 3 represents a group of customers who emphasizes performance and do not emphasize reliability so much with respect to the information processing device to be purchased. The group B represents a group of customers who do not emphasize reliability and performance so much with respect to the information processing device. The group C represents a group of customers who place importance on reliability and performance with respect to the information processing device. The group D represents a group of customers who emphasize reliability and do not emphasize performance so much with respect to the information processing device.

In the example illustrated in FIG. 3, the purchase estimation unit 121 in the estimation unit 12 estimates whether a certain customer purchases a certain information processing device (product) using the estimation model 150. At this time, the purchasing factor generation unit 122 in the estimation unit 12 generates a purchasing factor indicating that a customer emphasizes reliability and thus purchases a highly reliable information processing device and that a customer emphasizes performance and thus purchases a high performance information processing device.

The classification unit 13 classifies each customer into any one of the groups A to D described above based on the degree of emphasizing reliability with respect to the product and the degree of emphasizing reliability with respect to the product, which are the attributes of the customer represented by the purchasing factor generated by the purchasing factor generation unit 122. At this time, the classification unit 13 may use, for example, a reference indicating a range of values indicating the degree of emphasizing reliability and a range of values indicating the degree of emphasizing reliability.

When receiving an input operation to select a symbol of a specific customer from among the customers in the graph displayed on the display screen 200 by the management terminal device 20, the output unit 14 may cause the management terminal device 20 to display the customer attribute information 101 related to the specific customer. For example, as illustrated in FIG. 3, in response to an input operation of selecting a symbol of a customer belonging to the group D (for example, an operation of moving a mouse cursor to a symbol representing the customer and clicking the mouse), the output unit 14 causes the management terminal device 20 to display that the identifier (for example, the name or the like) of the customer is a “customer D001” on the display screen 200.

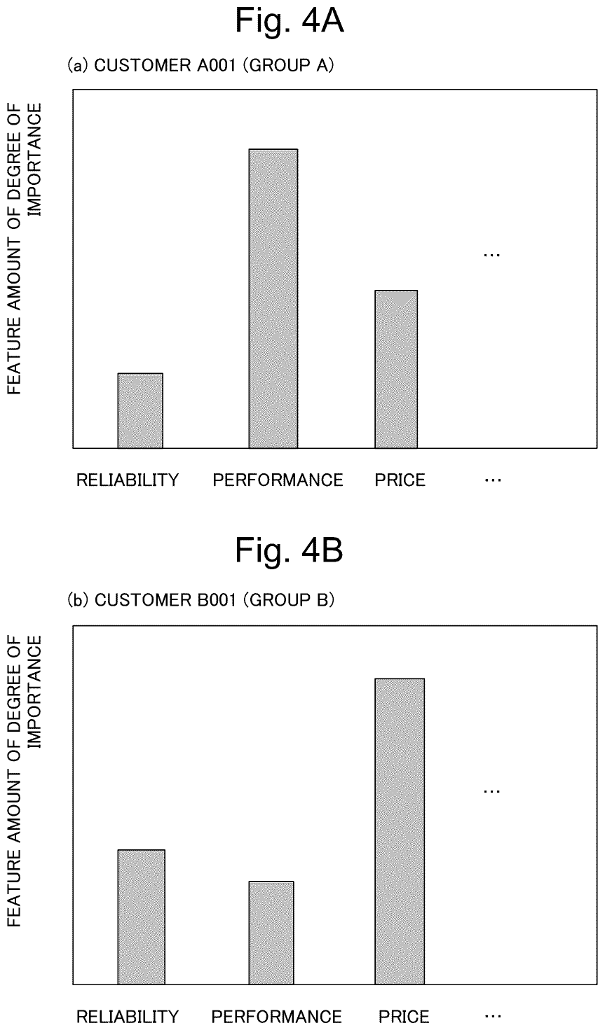

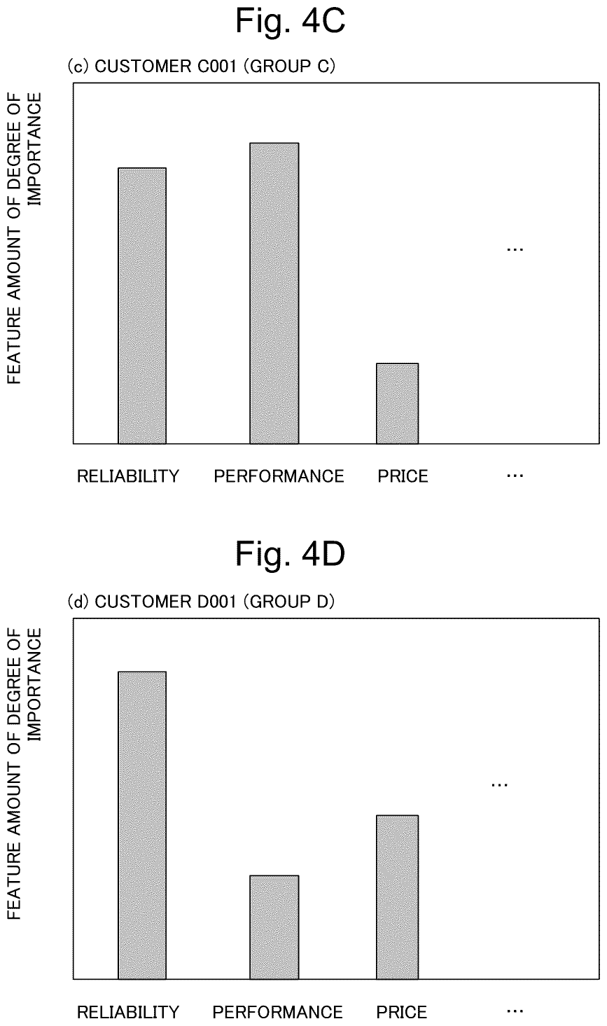

FIG. 4 is a diagram illustrating an aspect in which, when the management terminal device 20 receives an input operation of selecting a symbol of a specific customer from among customers in a graph displayed on the display screen 200, the management terminal device 20 displays details of the attribute of the specific customer under the control of the output unit 14.

For example, when the management terminal device 20 receives an input operation of selecting a symbol of any customer (customer A001) belonging to the group A exemplified in FIG. 3, the output unit 14 causes the management terminal device 20 to display the bar graph exemplified in (a) of FIG. 4 on the display screen 200. The bar graph illustrated in (a) of FIG. 4 indicates a feature amount of a degree of emphasizing a price of a product or the like in addition to a feature amount of a degree of emphasizing each of reliability and performance of the customer.

Similarly, when the management terminal device 20 receives an input operation of selecting a symbol of any customer (customer B001, customer C001, or customer D001) belonging to the groups B to D exemplified in FIG. 3, the output unit 14 causes the management terminal device 20 to display the bar graphs exemplified in (b) to (d) of FIG. 4 on the display screen 200.

According to the diagram exemplified in FIG. 4, it can be seen that the customer of the group B who does not emphasize reliability or performance of the product has a high degree of emphasizing the price of the product. It can be seen that the customer of the group C who emphasizes both reliability and performance of the product has a low degree of emphasizing the price of the product. It can be seen that the customers of the groups A and D who emphasize either reliability or performance of the product have a higher degree of emphasizing the price of the product than the group C and lower than the group B. The graph illustrated in FIG. 4 is information used in consideration of sales and development, by the user of the customer classification device 10, of a product suitable for a customer.

As illustrated in FIG. 4, the output unit 14 causes the management terminal device 20 to display, on the display screen 200, the attribute including an attribute, indicated by the customer attribute information 101, that is not illustrated in the graph illustrated in FIG. 3, regarding the customer selected by the input operation.

The output unit 14 may cause the management terminal device 20 to display the features of the customer attribute information 101 regarding the group displayed in the graph exemplified in FIG. 3. More specifically, for example, the output unit 14 may cause the management terminal device 20 to display, for each group, the average value of the values indicated by the customer attribute information 101 of the customers belonging to the each group in an aspect similar to the aspect illustrated in FIG. 4. That is, in this case, each bar graph exemplified in FIG. 4 does not represent the customer attribute information 101 regarding a specific customer, but represents, for example, an average value of values represented by the customer attribute information 101 regarding the customers belonging to the group for each group.

The management terminal device 20 may display, on the display screen 200, the graph illustrated in FIG. 4 in the same window as the window in which the graph illustrated in FIG. 3 is displayed, or may display the graph in a window different from that in FIG. 3.

The display aspect of the result of classifying the customers output by the output unit 14 is not limited to the aspects illustrated in FIGS. 3 and 4. The display aspect of the result of classifying the customers output by the output unit 14 may be, for example, a graph in a format different from that of each of FIGS. 3 and 4 or a text.

The model generation unit 15 described above may generate or update the estimation model 150 representing the relationship between the customer attribute information 101 and the product attribute information 102 regarding the customer belonging to the group, and the purchase history information 103 regarding the customer belonging to the group based on the result of classifying the customers by the classification unit 13.

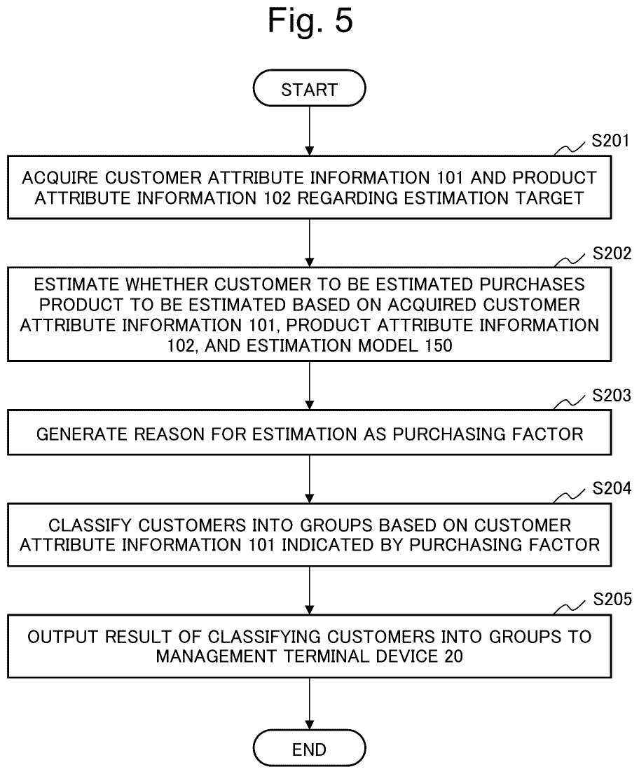

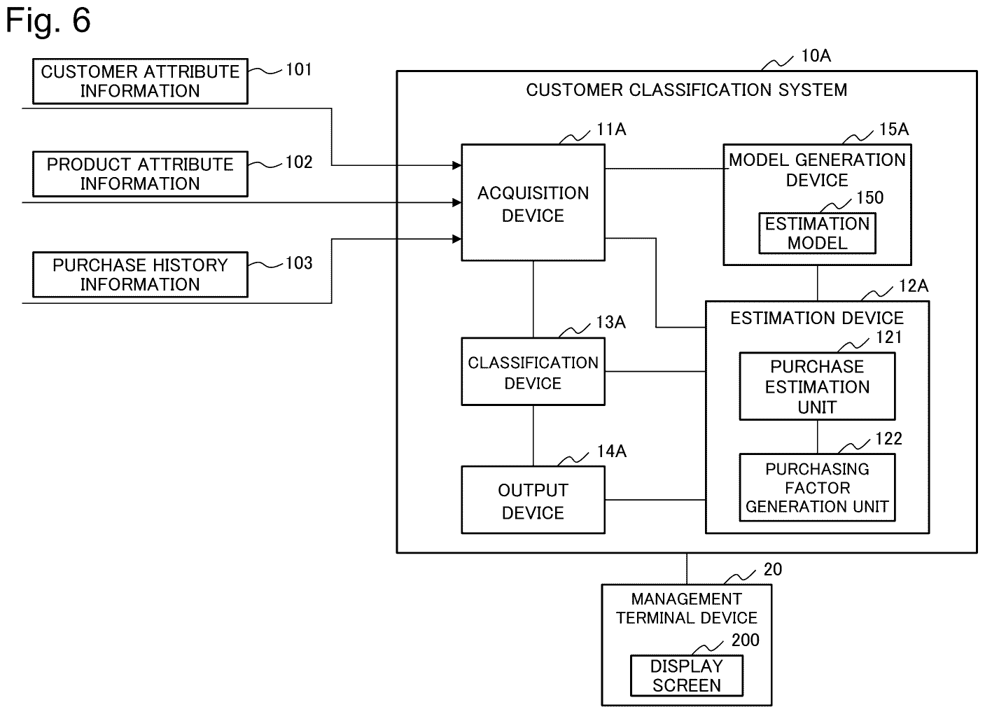

Next, an operation (processing) of classifying customers into groups by the customer classification device 10 according to the present example embodiment will be described in detail with reference to a flowchart of FIG. 5.

The acquisition unit 11 acquires customer attribute information 101 and product attribute information 102 regarding the estimation target (step S201). The purchase estimation unit 121 in the estimation unit 12 estimates whether the customer to be estimated purchases the product to be estimated based on the customer attribute information 101 and the product attribute information 102 acquired by the acquisition unit 11, and the estimation model 150 (step S202). The purchasing factor generation unit 122 in the estimation unit 12 generates the reason for estimation by the purchase estimation unit 121 as a purchasing factor by using the attention mechanism of deep learning (step S203).

The classification unit 13 classifies customers into groups based on the customer attribute information 101 indicated by the purchasing factor generated by the purchasing factor generation unit 122 (step S204). The output unit 14 outputs the result of classifying the customers into the groups by the classification unit 13 to the management terminal device 20 (step S205), and the entire processing ends.

The customer classification device 10 according to the present example embodiment can identify a purchasing factor even for a product whose characteristic is not sufficiently grasped, and thus can contribute to sales and development of the product matching the customer. This is because the customer classification device 10 estimates the purchasing factor with which the customer purchases the product based on the customer attribute information 101, the product attribute information 102, and the purchase history information 103, and classifies the customer based on the purchasing factor.

Hereinafter, effects achieved by the customer classification device 10 according to the present example embodiment will be described in detail.

In a case where customers are classified in order to sell or develop a product in accordance with customers, it is difficult to correctly identify a purchasing factor of the product unless customers are classified into groups in consideration of characteristics of the product. For example, at the time of starting sales of a certain AI product, it is assumed that customers are classified into groups with the business content as an axis based on past experience that “purchasing factors differ depending on the business content of the customer”, and sales measures are taken based on the purchasing factor analyzed for each group. However, in practice, there are many customers who use the AI product for the development of new business (that is, whether to purchase the AI product is not affected by the current business content), and the purchasing factor analyzed by classifying the customers from the current business content is inappropriate, and the sales measure cannot be said to be appropriate. As described above, in a case where the characteristic (attribute) of a product cannot be sufficiently grasped, it is difficult to analyze the purchasing factor related to the product, and thus, it is required to identify the purchasing factor even for the product whose characteristic cannot be sufficiently grasped.

To solve such a problem, the customer classification device 10 according to the present example embodiment includes the acquisition unit 11, the estimation unit 12, the classification unit 13, and the output unit 14, and operates as described above with reference to FIGS. 1 to 5, for example. That is, the acquisition unit 11 acquires the customer attribute information 101 regarding the customer, the product attribute information 102 regarding the product, and the purchase history information 103 indicating the purchase history of the product by the customer. Estimation unit 12 estimates a purchasing factor of the product by the customer based on the customer attribute information 101, the product attribute information 102, and the purchase history information 103. The classification unit 13 classifies the customer into a group based on the purchasing factor. Then, the output unit 14 outputs the result of classifying the customer.

That is, since the customer classification device 10 according to the present example embodiment estimates the purchasing factor based on the attributes of a customer and a product and the purchase history of the product by the customer, and classifies the customer based on the purchasing factor, so that the characteristic of the product is reflected in the result of classifying the customer. Therefore, the customer classification device 10 can identify a purchasing factor of customer for each group even for a product whose characteristic cannot be sufficiently grasped, and thus can contribute to sales and development of the product that matches the customer.

The customer classification device 10 according to the present example embodiment outputs a graph representing the value of the customer attribute information 101, the graph representing the result of classifying the customers, to the management terminal device 20, and in the graph, the customers are displayed in different aspects for the respective groups, for example, as illustrated in FIG. 3. As a result, the customer classification device 10 can present the result of classifying the customers to the user in an easy-to-understand manner.

When the management terminal device 20 receives an input operation of selecting a symbol of a specific customer among the customers displayed in the graph displayed on the display screen 200, the customer classification device 10 according to the present example embodiment causes the management terminal device 20 to display the customer attribute information 101 related to the specific customer as illustrated in FIG. 4, for example. As a result, the customer classification device 10 can support efficient consideration of sales and development, by the user, of a product that matches the customer.

The customer classification device 10 according to the present example embodiment causes the management terminal device 20 to display, for example as illustrated in FIG. 4, the feature of the customer attribute information 101 regarding the group displayed in the graph displayed on the display screen 200, for example, as illustrated in FIG. 3. As a result, the customer classification device 10 can support efficient consideration of sales and development, by the user, of a product that matches the customer.

The function implemented by the customer classification device 10 according to the present example embodiment described above may be implemented by a system including a plurality of information processing devices.

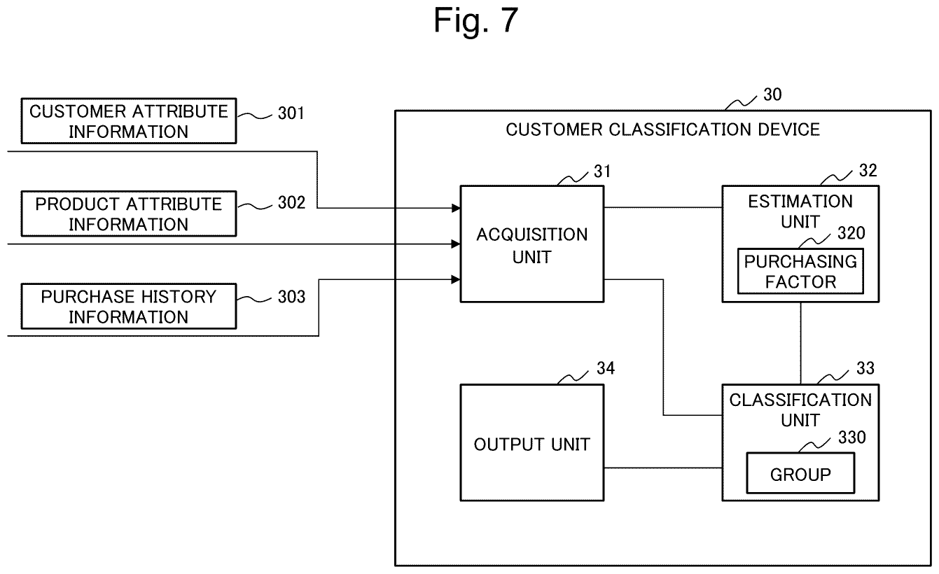

FIG. 7 is a block diagram illustrating a configuration of a customer classification system 10A according to a modification of the present example embodiment. The function of the customer classification system 10A is equivalent to that of the customer classification device 10 described above. The customer classification system 10A includes an acquisition device 11A, an estimation device 12A, a classification device 13A, an output device 14A, and a model generation device 15A, each of which is an information processing device. The acquisition device 11A, the estimation device 12A, the classification device 13A, the output device 14A, and the model generation device 15A have functions equivalent to those of the acquisition unit 11, the estimation unit 12, the classification unit 13, the output unit 14, and the model generation unit 15 described above, respectively. The acquisition device 11A, the estimation device 12A, the classification device 13A, the output device 14A, and the model generation device 15A are communicably connected to each other.

The configuration of the customer classification system 10A is not limited to the configuration including the information processing devices corresponding to the individual components of the customer classification device 10. For example, the customer classification system 10A may include a plurality of components of the customer classification device 10 as one information processing device.

### Second Example Embodiment

FIG. 7 is a block diagram illustrating a configuration of a customer classification device 30 according to the second example embodiment of the present invention. The customer classification device 30 includes an acquisition unit 31, an estimation unit 32, a classification unit 33, and an output unit 34. However, the acquisition unit 31, the estimation unit 32, the classification unit 33, and the output unit 34 are examples of an acquisition means, an estimation means, a classification means, and an output means, respectively.

The acquisition unit 31 acquires customer attribute information 301 about a customer, product attribute information 302 about a product, and purchase history information 303 indicating a purchase history of the product by the customer. The customer attribute information 301 is, for example, information similar to the customer attribute information 101 according to the first example embodiment. The product attribute information 302 is, for example, information similar to the product attribute information 102 according to the first example embodiment. The purchase history information 303 is, for example, information similar to the purchase history information 103 according to the first example embodiment. The acquisition unit 31 operates as in the acquisition unit 11 according to the first example embodiment, for example.

The estimation unit 32 estimates a purchasing factor 320 of the product by the customer based on the customer attribute information 301, the product attribute information 302, and the purchase history information 303. For example, the estimation unit 32 includes a configuration equivalent to that of the purchase estimation unit 121 and the purchasing factor generation unit 122 in the estimation unit 12 according to the first example embodiment, and estimates the purchasing factor 320 using an estimation model equivalent to the estimation model 150 according to the first example embodiment.

The classification unit 33 classifies the customer into a group 330 based on the purchasing factor 320. For example, as in the classification unit 13 according to the first example embodiment, the classification unit 33 classifies the customer into the group 330 based on the customer attribute information 301 indicated by the purchasing factor 320.

The output unit 34 outputs the result of classifying the customer. For example, as in the output unit 14 according to the first example embodiment, the output unit 34 outputs the classification results of the aspects illustrated in FIGS. 3 and 4 to a device such as the management terminal device 20.

The customer classification device 30 according to the present example embodiment can identify a purchasing factor even for a product whose characteristic is not sufficiently grasped, and thus can contribute to sales and development of the product matching the customer. This is because the customer classification device 30 estimates the purchasing factor 320 with which the customer purchases the product based on the customer attribute information 301, the product attribute information 302, and the purchase history information 303, and classifies the customer based on the purchasing factor 320.

### Hardware Configuration Example

Each unit of the customer classification device 10 illustrated in FIG. 1 or the customer classification device 30 illustrated in FIG. 7 in each of the above-described example embodiments can be achieved by dedicated hardware (HW) (electronic circuit). In FIGS. 1 and 7, at least the following configurations can be regarded as a function (processing) unit (software module) of a software program.
The acquisition units 11 and 31,
The estimation units 12 and 32,
The purchase estimation unit 121
The purchasing factor generation unit 122,
The classification units 13 and 33,
The output units 14 and 34, and
The model generation unit 15.

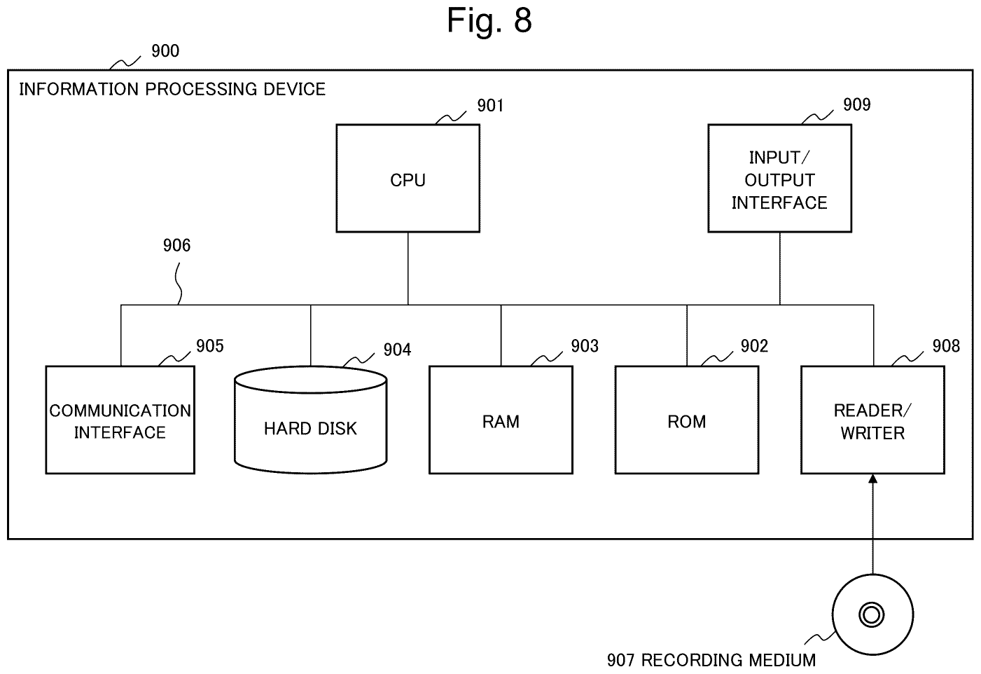

The division of each unit illustrated in these drawings is a configuration for convenience of description, and various configurations can be assumed at the time of implementation. An example of a hardware environment in this case will be described with reference to FIG. 8.

FIG. 8 is a diagram for exemplarily describing a configuration of an information processing device 900 (computer system) capable of implementing the customer classification device 10 according to the first example embodiment or the customer classification device 30 according to the second example embodiment of the present invention. That is, FIG. 8 is a configuration of at least one computer (information processing device) capable of achieving the customer classification devices 10 and 30 illustrated in FIGS. 1 and 7, and represents a hardware environment capable of implementing each function in the above-described example embodiment.

The information processing device 900 illustrated in FIG. 8 includes the following components as components, but may not include some of the following components:
A central processing unit (CPU) 901,
A read only memory (ROM) 902,
A random access memory (RAM) 903,
A hard disk (storage device) 904,
A communication interface 905 with an external device,
A bus 906 (communication line),
A reader/writer 908 capable of reading and writing data stored in a recording medium 907 such as a compact disc read only memory (CD-ROM), and
An input/output interface 909 such as a monitor, a speaker, or a keyboard.

That is, the information processing device 900 including the above-described components is a general computer to which these components are connected via the bus 906. The information processing device 900 may include a plurality of CPUs 901 or may include a CPU 901 configured by a plurality of cores. The information processing device 900 may include a Graphical_Processing_Unit (GPU) (not illustrated) in addition to the CPU 901.

Then, the present invention described using the above-described example embodiment as an example supplies a computer program capable of achieving the following functions to the information processing device 900 illustrated in FIG. 8. The function is the above-described configuration in the block configuration diagram (FIGS. 1 and 7) referred to in the description of the example embodiment or the function of the flowchart (FIGS. 2 and 5). Thereafter, the present invention is achieved by reading, interpreting, and executing the computer program on the CPU 901 of the hardware. The computer program supplied into the device may be stored in a readable/writable volatile memory (RAM 903) or a non-volatile storage device such as the ROM 902 or the hard disk 904.

In the above case, a general procedure can be used at present as a method of supplying the computer program into the hardware. Examples of the procedure include a method of installing the program in the device via various recording media 907 such as a CD-ROM, a method of downloading the program from the outside via a communication line such as the Internet, and the like. In such a case, the present invention can be understood to be configured by a code constituting the computer program or the recording medium 907 storing the code.

The present invention is described above using the above-described example embodiments as exemplary examples. However, the present invention is not limited to the above-described example embodiments. That is, it will be understood by those of ordinary skill in the art that the present invention can have various aspects without departing from the spirit and scope of the present invention as defined by the claims.

Note that part or all of each example embodiment described above can also be described as the following Supplementary Notes. However, the present invention exemplarily described by the above-described example embodiments is not limited to the following.

### (Supplementary Note 1)

A customer classification device including
an acquisition means configured to acquire customer attribute information about a customer, product attribute information about a product, and purchase history information indicating a purchase history of the product by the customer,
an estimation means configured to estimate a purchasing factor of the product by the customer based on the customer attribute information, the product attribute information, and the purchase history information,
a classification means configured to classify the customer into a group based on the purchasing factor, and
an output means configured to output a result of classifying the customer.

### (Supplementary Note 2)

The customer classification device according to Supplementary Note 1, wherein
the output means outputs a graph representing the classification result to a display device, and wherein
in the graph, the customers are displayed in different aspects for the respective groups.

### (Supplementary Note 3)

The customer classification device according to Supplementary Note 2, wherein
in the graph, the customers are displayed by symbols having different shapes or colors for the respective groups.

### (Supplementary Note 4)

The customer classification device according to Supplementary Note 2 or 3, wherein
the graph includes a figure surrounding the customers belonging to the same group.

### (Supplementary Note 5)

The customer classification device according to any one of Supplementary Notes 2 to 4, wherein
when the display device receives an input operation of selecting a symbol of a specific customer from among symbols indicating the customers displayed in the graph, the output means displays the customer attribute information related to the specific customer.

### (Supplementary Note 6)

The customer classification device according to any one of Supplementary Notes 2 to 5, wherein
the output means displays a feature of the customer attribute information about the group displayed in the graph.

### (Supplementary Note 7)

The customer classification device according to Supplementary Note 6, wherein
the output means displays, for the each group, an average value of values indicated by the customer attribute information about the customers belonging to the each group.

### (Supplementary Note 8)

The customer classification device according to any one of Supplementary Notes 1 to 7, wherein
the customer attribute information includes
at least one of an age, a gender, an occupation, an income, a nationality, a family structure, a place of residence, a body shape, a hobby, a taste, an action history, a job category, and a position of the customer in a case where the customer is an individual, and
at least one of a type, the number of years since establishment, an industry type, a place of a head office and a place of a business, revenue, capital, the number of employees, an activity history, and a form of business of the customer in a case where the customer is an organization.

### (Supplementary Note 9)

The customer classification device according to any one of Supplementary Notes 1 to 8, wherein
the product attribute information includes at least one of a product name, a product identifier, a type, a quantity, a price, performance, reliability, quality, appearance, a manufacturer, a seller, a raw material, and a release date of the product.

### (Supplementary Note 10)

The customer classification device according to any one of Supplementary Notes 1 to 9, wherein
the estimation means includes
a purchase estimation means configured to estimate whether the customer purchases the product based on an estimation model that was trained on a relationship between the customer attribute information and the product attribute information, and the purchase history information, and
a purchasing factor generation means configured to generate a reason for estimation by the purchase estimation means as the purchasing factor.

### (Supplementary Note 11)

The customer classification device according to Supplementary Note 10, further including
a model generation means configured to generate the estimation model, wherein
the model generation means generates the estimation model representing a relationship between the customer attribute information about the customer belonging to the group and the product attribute information, and the purchase history information about the customer belonging to the group based on the classification result.

### (Supplementary Note 12)

The customer classification device according to Supplementary Note 10 or 11, wherein
the estimation model includes a model using an attention mechanism.

### (Supplementary Note 13)

A customer classification system including
an acquisition means configured to acquire customer attribute information about a customer, product attribute information about a product, and purchase history information indicating a purchase history of the product by the customer,
an estimation means configured to estimate a purchasing factor of the product by the customer based on the customer attribute information, the product attribute information, and the purchase history information,
a classification means configured to classify the customer into a group based on the purchasing factor, and
an output means configured to output a result of classifying the customer.

### (Supplementary Note 14)

A customer classification method executed by an information processing device, the method including
acquiring customer attribute information about a customer, product attribute information about a product, and purchase history information indicating a purchase history of the product by the customer,
estimating a purchasing factor of the product by the customer based on the customer attribute information, the product attribute information, and the purchase history information,
classifying the customer into a group based on the purchasing factor, and
outputting a result of classifying the customer.

### (Supplementary Note 15)

A recording medium storing a customer classification program for causing a computer to execute
an acquisition process of acquiring customer attribute information about a customer, product attribute information about a product, and purchase history information indicating a purchase history of the product by the customer,
an estimation process of estimating a purchasing factor of the product by the customer based on the customer attribute information, the product attribute information, and the purchase history information,
a classification process of classifying the customer into a group based on the purchasing factor, and
an outputting process of outputting a result of classifying the customer.

### REFERENCE SIGNS LIST

10 customer classification device
10A customer classification system
101 customer attribute information
102 product attribute information
103 purchase history information
11 acquisition unit
11A acquisition device
12 estimation unit
12A estimation device
121 purchase estimation unit
122 purchasing factor generation unit
13 classification unit
13A classification device
14 output unit
14A output device
15 model generation unit
150 estimation model
15A model generation device
20 management terminal device
200 display screen
30 customer classification device
301 customer attribute information
302 product attribute information
303 purchase history information
31 acquisition unit
32 estimation unit
320 purchasing factor
33 classification unit
330 group
34 output unit
900 information processing device
901 CPU
902 ROM
903 RAM
904 hard disk (storage device)
905 communication interface
906 bus
907 recording medium
908 reader/writer
909 input/output interface

What is claimed is:

1. A customer classification device comprising:
at least one memory storing a computer program; and
at least one processor configured to execute the computer program to
acquire customer attribute information about a customer, product attribute information about a product, and purchase history information indicating a purchase history of the product by the customer;
estimate a purchasing factor of the product by the customer based on the customer attribute information, the product attribute information, and the purchase history information;
classify the customer into a group based on the purchasing factor; and
output a result of classifying the customer.

2. The customer classification device according to claim 1, wherein the processor is configured to execute the computer program to
output a graph representing the classification result to a display device, and wherein
in the graph, the customers are displayed in different aspects for the respective groups.

3. The customer classification device according to claim 2, wherein
in the graph, the customers are displayed by symbols having different shapes or colors for the respective groups.

4. The customer classification device according to claim 2, wherein
the graph includes a figure surrounding the customers belonging to the same group.

5. The customer classification device according to claim 2, wherein the processor is configured to execute the computer program to,
when the display device receives an input operation of selecting a symbol of a specific customer from among symbols indicating the customers displayed in the graph, display the customer attribute information related to the specific customer.

6. The customer classification device according to claim 2, wherein the processor is configured to execute the computer program to
display a feature of the customer attribute information about the group displayed in the graph.

7. The customer classification device according to claim 6, wherein the processor is configured to execute the computer program to
display, for the each group, an average value of values indicated by the customer attribute information about the customers belonging to the each group.

8. The customer classification device according to claim 1, wherein
the customer attribute information includes
at least one of an age, a gender, an occupation, an income, a nationality, a family structure, a place of residence, a body shape, a hobby, a taste, an action history, a job category, and a position of the customer in a case where the customer is an individual, and
at least one of a type, the number of years since establishment, an industry type, a place of a head office and a place of a business, revenue, capital, the number of employees, an activity history, and a form of business of the customer in a case where the customer is an organization.

9. The customer classification device according to claim 1, wherein
the product attribute information includes at least one of a product name, a product identifier, a type, a quantity, a price, performance, reliability, quality, appearance, a manufacturer, a seller, a raw material, and a release date of the product.

10. The customer classification device according to claim 1, wherein the processor is configured to execute the computer program to
estimate whether the customer purchases the product based on an estimation model that was trained on a relationship between the customer attribute information and the product attribute information, and the purchase history information, and
generate a reason for estimation by the purchase estimation means as the purchasing factor.

11. The customer classification device according to claim 10, wherein the processor is configured to execute the computer program to
generate the estimation model representing a relationship between the customer attribute information about the customer belonging to the group and the product attribute information, and the purchase history information about the customer belonging to the group based on the classification result.

12. The customer classification device according to claim 10, wherein
the estimation model includes a model using an attention mechanism.

13. (canceled)

14. A customer classification method executed by an information processing device, the method comprising:
acquiring customer attribute information about a customer, product attribute information about a product, and purchase history information indicating a purchase history of the product by the customer;
estimating a purchasing factor of the product by the customer based on the customer attribute information, the product attribute information, and the purchase history information;
classifying the customer into a group based on the purchasing factor; and
outputting a result of classifying the customer.

15. A non-transitory computer-readable recording medium storing a customer classification program for causing a computer to execute:
an acquisition process of acquiring customer attribute information about a customer, product attribute information about a product, and purchase history information indicating a purchase history of the product by the customer;
an estimation process of estimating a purchasing factor of the product by the customer based on the customer attribute information, the product attribute information, and the purchase history information;
a classification process of classifying the customer into a group based on the purchasing factor, and
an outputting process of outputting a result of classifying the customer.
